(19) United States
(12) Patent Application Publication
(10) Pub. No.: US 2024/0377138 A1
(43) Pub. Date: Nov. 14, 2024

(54) HYBRID PROCESS AND HYBRID DEVICE FOR LOW-CO2 OR FOR CO2-FREE HIGH-TEMPERATURE TECHNOLOGIES FOR THE THERMAL TREATMENT OR PRODUCTION OF INORGANIC MATERIALS

(71) Applicant: TECHNISCHE UNIVERSITÄT BERGAKADEMIE FREIBERG, Freiberg (DE)

(72) Inventors: Christos G. ANEZIRIS, Freiberg (DE); Patrick GEHRE, Freiberg (DE); Christian WEIGELT, Freiberg (DE); Steffen DUDCZIG, Freiberg (DE); Jana HUBÁLKOVÁ, Freiberg (DE)

(73) Assignee: TECHNISCHE UNIVERSITÄT BERGAKADEMIE FREIBERG, Freiberg (DE)

(21) Appl. No.: 18/692,665

(22) PCT Filed: Sep. 16, 2022
(86) PCT No.: PCT/EP2022/075727

§ 371 Date: Mar. 15, 2024

(30) Foreign Application Priority Data
Sep. 17, 2021 (DE) 10 2021 004 675.7

(51) Int. Cl. F27D 99/00; H05H 1/46

(52) U.S. Cl. CPC F27D 99/0006; F27D 99/0033; H05H 1/461; F27D 2099/0031; H05H 2245/80

(57) ABSTRACT

The invention relates to a hybrid process and a hybrid device for the production or thermal treatment of inorganic raw substances or materials in combination with further organic additives with the use of at least one gas burner in combination with at least one plasma burner in a furnace facility.

The generation of power and hydrogen by means of renewable energies offers new possibilities for low-CO₂ or for CO₂-free high-temperature technologies for the production or thermal treatment of inorganic materials. Owing to conventional energy-intensive sintering and melting processes, the sintering of ceramics, refractory ceramics, composite materials, the melting of glass or metal materials, the production of cement, etc., cause high CO₂ emissions. Many types of furnaces are used as furnace facilities, such as gas furnaces, sintering furnaces, continuous furnaces, tunnel furnaces, rotary kilns, melting furnaces, treatment furnaces, heat-retention furnaces, etc.

Hydrogen is already used as a reducing agent in the steel industry or is used as a gas in fuel cells for generating power. The major use-potential for hydrogen-based technologies is, inter alia, its storage life in the context of energy storage. However, the direct combustion of hydrogen in high-temperature furnaces for the production or melting or thermal heat treatment of inorganic materials does not appear to be lucrative, since, in the example of the combustion of methane compared with hydrogen, approximately only one third of the heating or calorific value is achieved when only hydrogen is combusted. This indicates that larger hydrogen gas volumes are necessary in order to achieve corresponding heating values/calorific values as in conventional gas fuels.

A further problem when using hydrogen is the formation of water vapour and its interaction with the inorganic materials. In the example of raw substances containing MgO, this can lead to the harmful formation of brucite (Mg(OH)₂), which negatively affects the final properties (porosity, strength, etc.) of MgO-containing ceramics or refractory ceramics. In the example of SiC heating elements, the water vapour reacts with the SiO₂ passivation layer and thus the service life of the SiC-containing heating elements is significantly impaired. The harmful effect of water vapour is also known in the example of partially or fully stabilised zirconium dioxides, which can lead to considerable strength losses in these products owing to the destabilisation of the zirconium dioxide.

Thermal plasmas can be generated technically by means of inductive coupling-in of high-frequency fields in the MHz range, by means of microwave coupling-in in the GHz range or by direct-current coupling-in (arc discharges). In accordance with the different types of generation of the plasma, a distinction is made between direct-current, induction, and microwave plasma burners.

Plasma burners that use current as the primary energy source offer an enormous potential for providing, for high-temperature processes, low-CO₂ or for CO₂-free technologies for the production or thermal treatment of inorganic materials.

DE 38 73 193 T2 describes a plasma-assisted process for powder production. U.S. Pat. No. 7,189,940 B2 and U.S. Pat. No. 7,638,727 B2 disclose an apparatus and a method for plasma-assisted melting or a plasma-assisted heat treatment. US 2006/0057016 A1 describes a plasma-assisted sintering process and system. U.S. Pat. No. 7,445,817 B2 shows a plasma-assisted process for producing carbon structures.

Common to the above-mentioned inventions is that a plasma or plasma burner is used for the energy input for the described high-temperature processes. However, due to the rapid, high energy input owing to the use of a plasma burner, thermomechanical stresses arise in the furnace facility, in particular in the case of the fire-resistant lining, which can considerably reduce the service life thereof.

The technical problem addressed by the invention is therefore that of providing a process for the plasma-based thermal treatment of inorganic materials, which process is low-CO₂ or CO₂-free in comparison with the combustion of fossil-based raw substances. The problem is solved by combining, for the thermal-treatment process, a plasma burner with a gas burner which, inter alia, combusts hydrogen, methane, propane, butane, natural gas or mixtures thereof.

According to the invention, the combination of hydrogen gas burners with plasma burners, when renewable energy is used as the primary energy for obtaining hydrogen and as the primary energy for operating plasma burners, leads to CO₂-free high-temperature technologies for the production or thermal treatment of inorganic materials. According to the invention, the gas burner as a thermal energy source provides gentle heating of the furnace chamber to temperatures below 1000° C., preferably below 600° C., and compensates for the temperature inhomogeneity at temperatures below 1000° C., preferably below 600° C. According to the invention, the operating use of the plasma burner is then implemented in order to achieve high sintering or melting temperatures.

The hybrid process according to the invention and the hybrid device according to the invention consist of a furnace facility having at least one gas burner for the combustion of hydrogen, methane, propane, butane, natural gas or mixtures thereof combined with at least one plasma burner in order to thermally treat, sinter, carbonise, pyrolyse, melt or oxidise inorganic raw substances with or without carbon or further organic additives, ceramics, refractory ceramics, glass, cement, metals, composite materials or carbon- containing or carbon-bound products.

Preferably, a ceramic or refractory ceramic according to the invention consists of for example Al₂O₃, ZrO₂, Cr₂O₃, SiO₂, MgO, MgAl₂O₄, La₂O₃, TiO₂, CaO, LaCrO₃, CaZrO₃, SiC, B₄C, ZrB₂, Si₃N₄, AIN, C, BaO, BaTiO₃ or mixtures thereof. Particularly preferably, the refractory ceramic is selected from Al₂O₃, ZrO₂, MgO, MgAl₂O₄, TiO₂, CaO, C or mixtures thereof. Metals having a melting point greater than 600° C., Cu, Fe, Si, Ni, Ti, Al, Mg or mixtures thereof are preferably used in the refractory ceramics.

Composite materials according to the invention consist of a ceramic and a metal fraction with or without carbon or also composite materials on the basis of only different carbon types. According to the invention, inter alia, steel or iron, iron and steel alloys, aluminium and aluminium alloys, Cu, Ni, Ti, Mo, W, Ta, Nb, and further refractory metals are used as metal for the metalloceramic composite materials.

According to the invention, the atmosphere in the furnace facility can consist of air, nitrogen, argon, hydrogen, water vapour, oxygen, or mixtures thereof.

For gentle heating of the furnace facility, according to the invention, from room temperature, the hydrogen-operated gas burner or burners are switched on and, preferably from 200° C., the plasma burner or burners are put into operation. According to the invention, microwave plasma burners are preferably used as plasma burners. According to the invention, what are known as active or passive catalysts (e.g. nanoscale titanium dioxide powder, carbon black, carbon nanotubes, etc.) can assist with microwave plasma heating. According to the invention, passive or active catalysts can be generated or introduced via the gas burner.

1-6. (canceled)

7. A device for thermally treating, sintering or melting inorganic raw substances with or without carbon or further organic additives for the production or thermal post-treatment of ceramics, refractory ceramics, glass, cement, metals, composite materials or carbon-containing or carbon-bonded products, characterised in that at least one gas burner for the combustion of hydrogen, methane, propane, butane, natural gas or mixtures thereof is combined with at least one plasma burner in a furnace facility.

8. The device according to claim 7, characterised in that a microwave plasma burner is used as plasma burner.

9. A process for thermally treating, sintering or melting inorganic raw substances with or without carbon or further organic additives for the production or thermal post-treatment of ceramics, refractory ceramics, glass, cement, metals, composite materials or carbon-containing or carbon-bonded products, characterised in that at least one gas burner for the combustion of hydrogen, methane, propane, butane, natural gas or mixtures thereof is combined with at least one plasma burner in a furnace facility.

10. The process according to claim 9, characterised in that the gas burner or burners are switched on during the combustion of only hydrogen for gentle heating of the furnace facility from room temperature, and in that the plasma burner or burners are switched on from 200° C. or at higher temperatures.

11. The process according to claim 9, characterised in that the gas burner or burners are switched off from temperatures of 1200° C. during the combustion of only hydrogen.

12. The process according to claim 9, characterised in that a microwave plasma burner is used as plasma burner.

13. The process according to claim 9, characterised in that passive or active catalysts assist the microwave plasma heating.

14. The process according to claim 9, characterised in that passive or active catalysts are generated and/or introduced via the gas burner.
